(19) United States
(12) Patent Application Publication
(10) Pub. No.: US 2011/0156325 A1
(43) Pub. Date: Jun. 30, 2011

(54) Numerically Controlled Tool Holding Device for Blast Machining

(75) Inventor: Tamer Cansiz, Niddatal-Bonstadt (DE)

(73) Assignee: Easb Cutting Systems GmbH, Karben (DE)

(21) Appl. No.: 13/058,672

(22) PCT Filed: Jul. 23, 2009
(86) PCT No.: PCT/EP2009/059515

§ 371 Date: Feb. 24, 2011

(30) Foreign Application Priority Data
Aug. 13, 2008 (DE) 10 2008 038 103.9

(51) Int. Cl. B23K 7/10; B23K 7/00

(52) U.S. Cl. 266/48

(57) ABSTRACT

The invention relates to a numerically controlled tool-holding device for jet/beam cutting. It is a device designed specifically for the requirements of jet/beam cutting of thick, plate-shaped components, and it is to be understood as a component of a gantry-type, robot-like machine. With the aid of this device it is possible to change the orientation of the jet/beam-producing tool (3) relative to the component and to produce the bevel forms which are usual in this plate thickness range—very flat bevels of great length are typical—without the risk of collisions and with particularly great accuracy. The device is designed to withstand the environmental stress which prevails during jet/beam cutting of thick, plate-shaped components, i.e. great heat and the production of large amounts of dust. It is characterized in that the tip of the torch or the TCP (6) of a jet/beam-producing tool (3) has a normal distance from the pivot axis (4) which is greater than the extent of the housing (8) in a plane perpendicular to said pivot axis (4), and the horizontal part of the connecting element (5a) is designed in such a manner that its distance from the pivot axis (4) is greater than that between the TCP (6) and said pivot axis (4), and the range of motion of the jet/beam-producing tool (3) about the pivot axis (4) is significantly greater than 180 degrees.

The invention relates to a numerically controlled tool-holding device for jet/beam cutting.

It is a device designed specifically for the requirements of jet/beam cutting of thick, plate-shaped components, and it is to be understood as a component of a gantry-type, robot-like machine. With the aid of this device it is possible to change the orientation of the jet/beam-producing tool relative to the component and to produce the bevel forms which are usual in this plate thickness range—very flat bevels of great length are typical—without the risk of collisions and with particularly great accuracy. The device is designed to withstand the environmental stress which prevails during jet/beam cutting of thick, plate-shaped components, i.e. great heat and the production of large amounts of dust.

Devices for pivoting a tool on an industrial robot or a robot-like machine are referred to as robot wrists. Similar devices are used on five-axis milling machines, where they are called pivoting head.

A robot wrist normally consists of three axes of movement. For cutting as well as milling, two axes of movement are sufficient due to the rotational symmetry of the tool.

Robot wrists have been known for many years and with widely varying kinematic and structural designs (Hesse, St.: Industrieroboterpraxis. [Industrial robots in practice] Vieweg-Verlag Braunschweig, Wiesbaden, 1998), (Rosheim, Me.: Robot Wrist Actuator. John Wiley & Sons, New York, 1989). As a rule, these wrists are not designed for a specific technological task, but they are universal devices which can be adapted to various applications, though possibly not meeting all of the special requirements of a technological process as a consequence.

A wrist for cutting is described in DE 10 2005 041 462. A large number of gear elements are used to achieve a circular movement of the output element, i.e. the cutting torch, for example, while maintaining a comparatively high rigidity. The TCP (Tool Centre Point=tip of the torch) is arranged at the centre point of the circle described during said circular movement. At the same time, the perpendicular axis of a second moving unit passes through this point, thus enabling the torch to rotate about this point without restriction. Numerous machine elements are located in close proximity to the tip of the torch and only at a small distance from the component to be cut. To limit thermal stress acting on said elements, the wrist can only be used for low-capacity plasma torches and oxyfuel gas torches and therefore only for small cutting thicknesses. The collision zone of the wrist near the torch is rather large—in particular due to a component referred to as carrying belt, so that flat bevels with bevel angles well above 45 degrees cannot be cut.

DE 9416957 describes a comparable solution—based on a parallel crank mechanism—for use as an instrument guiding and holding device in medical engineering. The centre point of the circular movement is referred to as invariant point in this solution.

U.S. Pat. No. 5,286,006 describes a bevel cutting device comprising two torches, wherein—by means of an articulated joint mechanism—at least one torch can be pivoted about an axis along the trajectory tangent and in addition can be moved in a perpendicular direction in order to produce “roof-shaped” kerf walls. Due to the design of the pivoting mechanism, there is/are a large collision zone and numerous machine elements which are in close proximity to the TCP, similar to the technical solutions described above.

JP 02229670 describes a method for bevel cutting and a relevant device. To pivot the torch, it is moved on a curved guide element. This considerably increases the collision zone and absolutely prevents the torch from having a range of motion exceeding approximately 150 degrees. The position of the component is sensed by means of a distance sensor acting horizontally on the straight kerf wall which has been cut before. The TCP and the sensor are arranged one behind the other in the cutting direction. As a result, this solution is well suited to producing bevel cuts on straight component edges, but not suitable for producing contoured cuts.

U.S. Pat. No. 6,201,207 describes another similar technical solution. Two numerically controlled axes are arranged in such a manner that, due to the arrangement of two plane parallel crank mechanisms behind one another, the torch is pivoted about a fixed point which is located at the tip of the torch. As a result, the cables and hoses leading to the torch can be treated with care. This solution, however, requires an extremely large number of articulated joints and gear elements, thus making production more complex and costly as well as increasing the adverse effects of gear backlash and manufacturing tolerance. All elements and articulated joints must of course be arranged in close spatial proximity to the torch, and they are exposed to high thermal stress on the one hand and to dust and spatter on the other. Finally, there is an increased risk of collision due to the close proximity of the mechanisms to the component to be cut.

To adapt articulated arm industrial robots for use in difficult environmental conditions (dust, heat, humidity), standard robots have been developed further, thus providing special designs (KUKA-Roboter für die Gieβerei- and Schmiede-lndustrie. [KUKA robots for the foundry and forging industry] Company publication of KUKA Roboter GmbH, Hery-Park 3000, 86368 Gersthofen, 2005), by modifying the distal components, i.e. in particular the robot wrist. This includes dust-proof and pressurized water-proof seals, reinforced housings, and heat-resistant coatings which reflect thermal radiation. It is possible to adapt a cutting torch to such robots and to use them for high-performance oxyfuel gas cutting, and this is in fact done in practice in some cases. To protect the wrist and in order to cut flat bevels, the distance of the tip of the torch from the wrist must be selected to be comparatively large. This dramatically decreases the working envelope of the robot, and as a result even robots with a large working envelope are suited to very small component dimensions only. Due to the comparatively large distance of the TCP from the intersection of the axes of rotation of the wrist, the positioning accuracy of the robot is decreased, and there will be tolerances in the position of the TCP during referencing of the robot, which may possibly become unacceptably high.

DE 69210201 describes a solution for cooling a tool while sucking off the cut material at the same time. The cooling system is twofold. A closed inner housing side is provided with an oil inlet and an oil outlet in order to cool the drive elements, in this case fast moving spindles, in a closed cooling circuit. Perforated separating walls form a labyrinth which is intended to provide uniform cooling. A second cooling circuit serves to air-cool the tools which are driven by said spindles, wherein the air which is supplied via a connection to a distribution circuit within the housing is evenly distributed to the tools outside said housing. The media do not expand within the housing; the cooling effect is based only on the heat capacity of the oil on the one hand and of the air on the other.

According to the state of the art which has been cited above by way of example, there are no recorded solutions which are suited to jet/beam cutting, in particular to oxyfuel gas cutting of very thick plates, by means of gantry-type, robot-like machines in the prevailing conditions with regard to dust and heat.

The object of the invention is therefore to provide a tool-holding device which is designed for the requirements of jet/beam cutting of very thick components, which tool-holding device is to be designed and dimensioned in such a manner that it is able to withstand the heat that is generated during oxyfuel gas cutting of unusually thick components (>100 mm)—as a result of the cutting process on the one hand and as a result of preheating the component on the other, while said tool-holding device should in addition be able to produce extremely large bevel angles (>60 degrees) on plate-shaped components without collisions; it is intended that both the jet/beam-producing tool which is mounted in the tool-holding device and the tool-holding device itself be comprehensively and completely protected from being damaged during collisions.

It is intended that appropriate technical solutions ensure that the gear backlash which occurs in the drivetrain of the tool-holding device will not affect the positioning accuracy at the TCP of the tool.

Referencing, i.e. the identification of the zero point of the range of motion of the tool-holding device, once the machine has been switched on is to be done in such a manner that a high positioning accuracy can be achieved on the lower edge of the kerf even if the effective length of the tool (distance between the pivot axis and the lower edge of the kerf) is very long.

According to the invention, the aforesaid object is achieved as described below; the basic inventive ideas are set forth in patent claim 1. The further development of the invention is described in patent claims 2 to 9.

The following supplementary notes are necessary to better understand the teaching of the invention.

The tool-holding device according to the invention is located on a gantry-type, robot-like machine for jet/beam cutting which serves to machine very thick, plate-shaped components. An oxyfuel gas torch, i.e. the jet/beam-producing tool, is as a rule located very close to the component. It must be ensured that the oxyfuel gas torch is movable so as to meet the requirements of jet/beam cutting technology while maintaining highest positioning accuracy, and that potential collisions of said torch with the component to be machined or with peripheral units have no serious consequences for the tool-holding device.

Such a tool-holding device has the following structure:

A rotating device supports, by means of a cranked connecting element, a pivoting device which in turn holds, by means of a tool-supporting element which is arranged on the side thereof and on its imaginary pivot axis, a torch, i.e. the jet/beam-producing tool, which can be pivoted through more than 180°. The aforesaid pivot axis is inclined at an angle of not more than 30° relative to a horizontal plane.

The pivoting device is designed to be rotatable through 360° about an axis which exits on the bottom side of the rotating device. The rotating device is in turn arranged at the distal end of a guiding machine, e.g. a gantry robot.

The pivoting device includes a complete drive and measuring system, a reduction gear (pivot gear) and, on the input and output shafts of said gear, switching flags which are in effective contact with switching means for referencing, i.e. the identification of the zero position of the tool-holding device, wherein the measuring system operates incrementally and controls, via the pivot gear, the position of the element supporting a jet/beam-producing tool.

To compensate for articulated joint backlash within the drivetrain between the pivoting motor and the jet/beam-producing tool, a mechanical device which produces a constant torque is located on the pivot axis within the housing of the pivoting device, slightly before the exit thereof in the direction of the tool-supporting element. Said torque exceeds that which is caused due to technological forces and inertial forces of the jet/beam-producing tool.

The element which supports the jet/beam-producing tool is designed as a collision protection device by providing snug-fit connections which are closed by springs or permanent magnets and which will open and activate an electrical switching element which stops the machine if external forces exceeding the holding power are present.

Another protective mechanism is provided by the fact that the pivoting device is enclosed by a basket-shaped protective device which is arranged at a defined distance from the surface of the housing of the pivoting device that is closed on all sides. If this “basket” is touched, one or several closing flags which hold down switching pins will move, so that an emergency stop is achieved by interrupting power supply.

The jet/beam-producing tool may have a cranked design—besides a preferred straight design.

The housing of the pivoting device consists in particular of a metallic material which reflects the intense heat generated in the workplace and repels spatter, e.g. during oxyfuel gas cutting. The pivoting device is cooled in an appropriate manner by means of a gas, in particular air.

The invention will now be explained with reference to an exemplary embodiment.

In the figures:

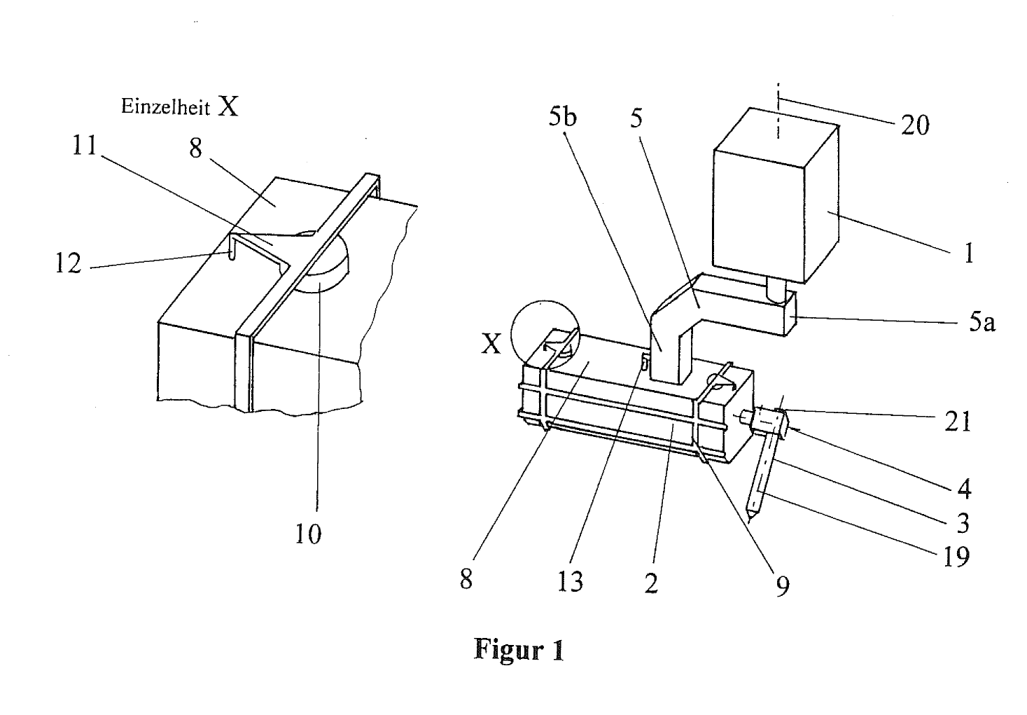

FIG. 1: shows a perspective general view of the tool-holding device;

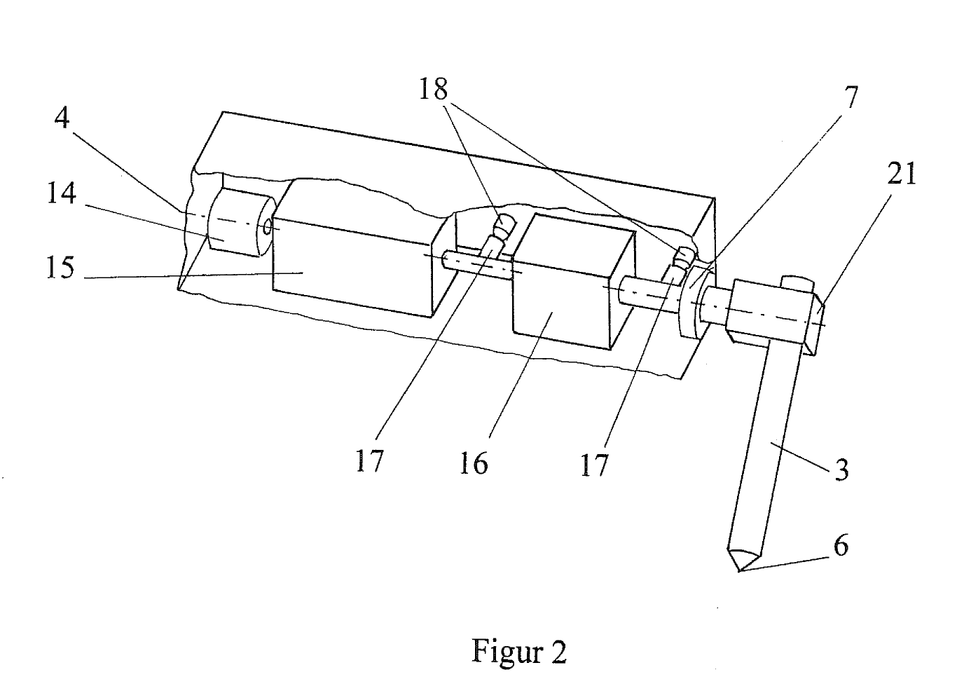

FIG. 2: shows a sectional view of the housing of the tool-holding device;

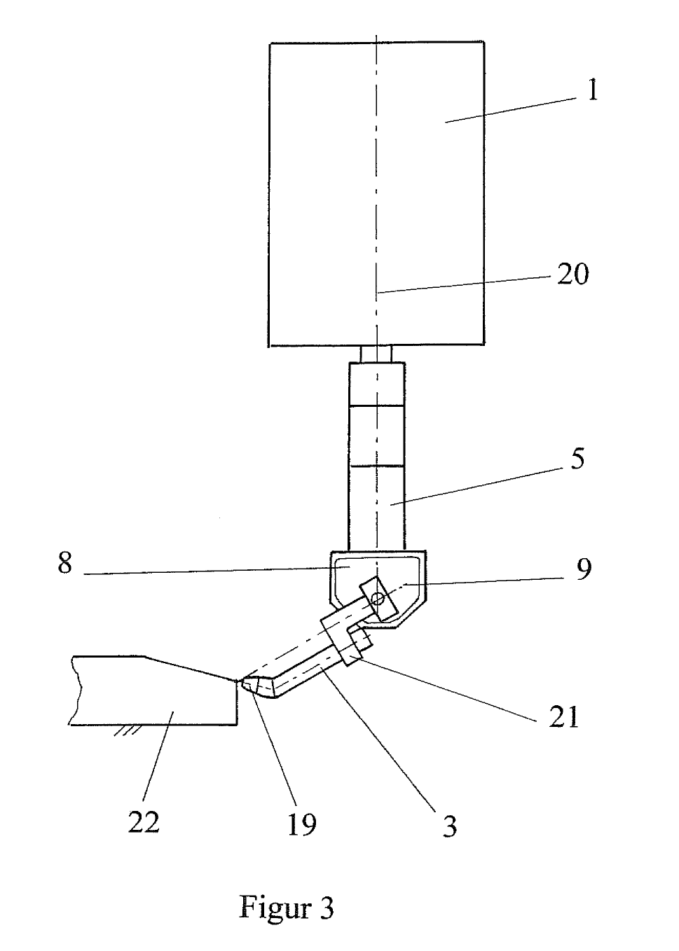

FIG. 3: shows a view of the tool-holding device during cutting of a flat bevel using a cranked torch.

Detail “X”: A detail of the basket-shaped protective device.

The tool-holding device is designed for jet/beam cutting, e.g. oxyfuel gas cutting, of very thick-walled, plate-shaped components. Besides contoured cuts, bevel cuts, often with extremely large bevel angles, can in particular be made.

A rotating device 1, arranged perpendicularly and connected to a Cartesian guiding machine, e.g. a gantry robot, in a proximal direction, is affixed, by means of a cranked connecting element 5, to a pivoting device 2 whose pivot axis 4 is located in a horizontal plane or encloses only a small angle with said plane. At least approximately aligned with the axis of the rotating device 1, a jet/beam-producing tool 3 is affixed on the pivot axis 4 of the pivoting device 2 by means of a torch holder 21.

The axis 19 of the jet/beam-producing tool 3 is parallel to the axis of the rotating device 1 in the normal position. All mechanical and measuring components which are required for numerically controlled operation of the rotating device 1 are installed in a housing 8, wherein a pivoting motor 15 including an incremental measuring system 14 acts on a pivot gear 16 which in turn is fixedly connected to the torch holder 21 and also to a mechanical device 7 which produces a torque. Said device can be designed as a pneumatic rotary vane motor or act like a torsion spring or helical spring. The mechanical device 7 produces an approximately constant torque acting in one direction between the frame of the pivoting device 2 and the output shaft of the pivot gear 16, which torque always exceeds that which the jet/beam-producing tool 3 and technological forces possibly caused by the operation thereof transmit, via the torch holder 21, to the output shaft of the pivot gear 16.

To increase the accuracy of referencing of the pivoting device 2 during start-up, a switching flag 17 is arranged on each of the input and output shafts of the pivot gear 16, which switching flags act on a switching means 18, e.g. a mechanical push button or a proximity switch, in each case. Both switching means 18 act as an opener, i.e. upon actuation by the switching flags 17, a current flow is interrupted, and they are connected in parallel in order to identify the reference position of the pivoting device 2.

To provide protection from the large amounts of dust and slags which are inevitably produced during jet/beam cutting, e.g. oxyfuel gas cutting, the housing 8 is completely closed off and its side surfaces and bottom side are made of a material which reflects thermal radiation and repels slag spatter. On the top side of the housing 8, a supply pipe 13 for a gaseous cooling agent, preferably air, is arranged, which cooling agent is injected at high pressure, passed through channels within the housing 8, expands, exits on the top side of the housing 8 at atmospheric pressure, and, due to its heat capacity on the one hand and to its decrease in temperature as a result of expansion on the other, serves to cool the housing 8 as well as all components which are located within said housing 8.

The housing 8 itself is formed in such a manner that the circumferential surface which is generated by the TCP 6 during pivoting about the pivot axis 4 completely encloses said housing. The mainly horizontal part of the cranked connecting element 5a in turn is arranged at a minimal distance from the pivot axis 4, which exceeds the distance of the TCP 6 from the pivot axis 4.

To protect the pivoting device 2 from collisions, the torch holder 21 is designed with a collision protection feature on the one hand, so that in case of a collision of the jet/beam-producing tool 3 a permanent magnetic or spring-biased snug-fit connection will open and a switching element will be actuated, and all outer surfaces of the housing 8, except for the cover surface and the end face where the torch holder 21 is located, are enclosed by a basket-shaped protective device 9 on the other. The clear distance of the basket-shaped protective device 9 from the housing 8 exceeds the stopping distance in case of an emergency stop of the machine. The basket-shaped protective device 9 is affixed to the top side of the housing 8 by means of at least one permanent magnet 10. On said housing, two switching pins 12 are arranged which are spring-biased and project from the housing 8 and which also actuate electrical switching elements. Said switching pins 12 are pressed into the housing 8 by means of two tapered closing flags 11 which are located on the basket-shaped protective device 9, thus closing the electrical switching elements. In case of a collision, the basket-shaped protective device 9 which is retained by means of (a) permanent magnet(s) is moved on the housing 8 or possibly even turn off, and the tapered closing flag 11 loses contact with the switching pin 12, which as a result will move outwards, thus no longer being able to keep the electrical switching element closed, so that the machine will be stopped by an emergency stop signal.

### LIST OF REFERENCE NUMERALS

1—Rotating device
2—Pivoting device
3—Jet/beam-producing tool
4—Pivot axis
5—Cranked connecting element
5a—mainly horizontal part of the cranked connecting element
5b—mainly vertical part of the cranked connecting element
6—Tool Centre Point (TCP)
7—Mechanical device for the production of a torque
8—Housing
9—Basket-shaped protective device
10—Permanent magnet
11—Tapered closing flag
12—Switching pin
13—Supply pipe
14—Incremental measuring system
15—Pivoting motor
16—Pivot gear
17—Switching flag
18—Switching means
19—Torch axis
20—Axis of the rotating device
21—Torch holder
22—Workpiece

1. A device for jet/beam cutting, having a perpendicular rotating device which is numerically controlled and can be rotated through at least 360 degrees and supporting a jet/beam-producing tool by means of a torch holder, wherein the axis of symmetry of said tool in the central position of its range of motion is parallel to and at least approximately aligned with the axis of the rotating device, comprising a pivoting device whose pivot axis is inclined at an angle of not more than 30 degrees relative to a horizontal plane, a housing which surrounds the pivot axis and whose main dimension extends along said pivot axis, and a cranked connecting element—consisting of a mainly vertical and a mainly horizontal part which are rigidly connected to each other—between the pivoting device and the rotating device, characterized in that wherein the tip of the torch or the (TCP) of a jet/beam-producing tool has a normal distance from the pivot axis which exceeds the extent of the housing in a plane perpendicular to said pivot axis, and the horizontal part of the connecting element is designed in such a manner that its distance from the pivot axis exceeds that between the TCP and said pivot axis, and the range of motion of the jet/beam-producing tool about the pivot axis is significantly greater than 180 degrees.

2. A device according to claim 1, characterized in that wherein a mechanical device producing a torque is located on the shaft of the pivot axis and is fixedly connected to the torch holder, wherein said device transmits to the shaft of the pivot axis an approximately constant torque acting in one direction, which torque in its amount exceeds that which is transmitted to said shaft due to technological forces and inertial forces of the jet/beam-producing tool.

3. A device according to claim 2, wherein the mechanical device producing a torque comprises a pneumatic rotary vane motor or as a torsion spring or helical spring.

4. A device according to claim 1, wherein the housing and the cranked connecting element enclose all components which are necessary for the numerically controlled operation of the pivoting device, and the bottom side and the side walls of the housing consist of a material to which hot slag spatter will not adhere and which has a surface that strongly reflects thermal radiation.

5. A device according to claim 1, wherein the housing is enclosed by a basket-shaped protective device which is arranged at a distance from said housing on the bottom side and the side walls which exceeds the emergency stopping distance of the gantry-type, robot-like machine, said basket-shaped protective device is connected to the housing on the top side of said housing by means of at least one permanent magnet and keeps pressed, by means of tapered closing flags, at least one switching pin which projects from the housing, which pin in turn closes a switching device which is integrated in the emergency stop circuit.

6. A device according to claim 1, wherein the housing itself and the components located within said housing are cooled by means of a gas which can be passed into the housing at high pressure via a supply pipe and can be passed along a defined path while it expands.

7. A device according to claim 1 comprising an incremental measuring system, wherein said measuring system is flange-mounted on the shaft of a pivoting motor, and for referencing of said motor a switching flag is affixed to each of the input and output shafts of a pivot gear, said switching flags act on a switching means acting as an opener in each case, and said switching means are connected in parallel.

8. A device according to claim 1, wherein for referencing of the rotating device a switching flag is affixed to each of the input and output shafts of its reduction gear, said switching flags act on a switching means acting as an opener in each case, and the two switching means are connected in parallel.

9. A device according to claim 1, wherein the jet/beam-producing tool is cranked in such a manner that the non-cranked part of the jet/beam-producing tool is parallel to the axis of the rotating device in the normal position, and the axis of its non-cranked part, if moved into the TCP of the jet/beam-producing tool, intersects the pivot axis.
